(19) United States
(12) Patent Application Publication
(10) Pub. No.: US 2019/0283066 A1
(43) Pub. Date: Sep. 19, 2019

(54) CONDITIONING DEVICE, PROCESSING INSTALLATION HAVING A CONDITIONING DEVICE AND METHOD FOR OPERATING A CONDITIONING DEVICE

(71) Applicant: EISENMANN SE, Boblingen (DE)

(72) Inventor: Wolfgang Rauser, Ebhausen (DE)

(21) Appl. No.: 16/299,374

(22) Filed: Mar. 12, 2019

(30) Foreign Application Priority Data
Mar. 13, 2018 (DE) 10 2018 105 722.9

(51) Int. Cl. B05B 16/60; B05B 16/20; B05B 16/40; B05B 13/04

(52) U.S. Cl. CPC B05B 16/60; B05B 13/0452; B05B 16/40; B05B 16/20

(57) ABSTRACT

A conditioning device for conditioning a gaseous medium to form a conditioned gaseous process medium having an inlet connection device and an outlet connection device between which a flow path for gaseous medium having at least one heating device for heating gaseous medium, is formed. The heating device is connected to an internal combustion engine heat pump system having at least one internal combustion engine so that the waste heat of the internal combustion engine can be used to heat the gaseous medium. A method for operating a conditioning device for conditioning a gaseous medium to form a conditioned gaseous process medium, wherein a flow path for gaseous medium is formed between an inlet connection device and an outlet connection device, the flow path having at least one heating device for heating gaseous medium. The heating device uses the waste heat of an internal combustion engine of an internal combustion engine heat pump system to heat the gaseous medium.

### RELATED APPLICATIONS

The present application claims priority to German Patent Application No. 10 2018 105 722.9 filed Mar. 13, 2018, the contents of which are fully incorporated herein by reference.

### FIELD OF THE INVENTION

The invention relates to a conditioning device for conditioning a gaseous medium to form a conditioned gaseous process medium, having an inlet connection device and an outlet connection device between which a flow path for gaseous medium having at least one heating device, by means of which the gaseous medium can be heated, is formed.

The invention further relates to an installation for processing workpieces, in particular for drying or coating workpieces, having a conditioning device for conditioning a gaseous medium to form a conditioned gaseous process medium.

The invention further relates to a method for operating a conditioning device for conditioning a gaseous medium to form a conditioned gaseous process medium, having an inlet connection device and an outlet connection device between which a flow path for gaseous medium having at least one heating device by means of which the gaseous medium can be heated is formed.

### BACKGROUND OF THE INVENTION

Conditioning devices of the type mentioned in the introduction are used, for example, in the automotive industry in installations for processing vehicle bodyworks and there in particular in processing booths, in which coated vehicle bodyworks are processed in the context of a painting process. These include in particular dryers or coating booths, but also, for example, flash-off booths or cooling booths, which all have a processing tunnel in which the corresponding processing operation is carried out.

In such processing booths, the tunnel air is circulated and to this end is discharged as gaseous medium which is intended to be conditioned from the processing tunnel and after conditioning in a conditioning device is supplied to the processing tunnel again as conditioned process medium. The tunnel air may contain components which are released when the workpieces are processed and which have to be removed from the tunnel air. In a conditioning device, the tunnel air which is removed passes through various conditioning stages in which the humidity and temperature of the tunnel air are adjusted and in which where applicable aggressive components can also be removed. In particular with dryers, a low level of humidity of the conditioned process medium is desirable.

In a dehumidification process, the gaseous medium is mostly cooled in several stages, wherein the humidity is condensed out. Generally, the medium which is thereby dehumidified is heated again in subsequent stages so that the process gas which is then conditioned is where possible supplied back into the processing tunnel at the same temperature at which the gaseous medium was removed from the processing tunnel.

### SUMMARY OF THE INVENTION

An object of the invention is to provide a conditioning device, an installation having a conditioning device and a method for operating a conditioning device for conditioning a gaseous medium and an installation and a method for processing workpieces which can be operated in a particularly energy-efficient manner.

This object may be achieved with a conditioning device of the type mentioned in the introduction in that
the heating device is connected to an internal combustion engine heat pump system having at least one internal combustion engine in such a manner that the waste heat of the internal combustion engine can be used to heat the gaseous medium.

In an internal combustion engine heat pump system which is known per se, the compressor unit, that is to say, the condenser or compressor, of the heat pump is operated using an internal combustion engine. Preferably, the internal combustion engine is a gas engine. Using such an internal combustion engine/heat pump system, heat transfer media, generally referred to as operating media, are cooled or heated for heat exchangers so that the heat exchangers can be used to control the temperature of, that is to say, to cool or heat, another, in particular gaseous medium. This medium may, for example, be the gaseous medium from the processing tunnel of a processing installation.

According to the invention, it has been recognized that the energy balance can be significantly improved if the necessarily produced waste heat of the internal combustion engine of the internal combustion engine heat pump system is used in order to heat the gaseous medium.

As a technical concept, it has been found to be advantageous if there is provided a flow circuit for a heating operating medium in which the heating operating medium circulates between at least one heating heat exchanger of the heating device and the internal combustion engine heat pump system, wherein the waste heat of the internal combustion engine is transferred by means of a waste heat exchanger to the heating operating medium.

It is advantageous if the flow circuit comprises a feed line which leads from the waste heat exchanger to the heating heat exchanger of the heating device and a return line between the heating heat exchanger and the waste heat exchanger, wherein the feed line and the return line are connected to each other by means of a circulation line in such a manner that heating operating medium from the feed line in the circuit can be guided into the return line again. In this manner, the influx of the heating operating medium to the heating heat exchanger can be changed.

In this instance, the circulation line preferably extends upstream of the heating heat exchanger away from the feed line.

Advantageously, there is provided a valve by means of which it is possible to adjust the proportion of the heating operating medium which flows from the feed line into the return line.

In a particularly preferred manner
a) there is formed in the flow path for gaseous medium at least one cooling device by means of which the gaseous medium can be cooled and which is arranged in particular upstream of the heating device;
b) the cooling device is connected to the internal combustion engine heat pump system in such a manner that a cooling operating medium which is cooled by the internal combustion engine heat pump system can be used to cool the gaseous medium.

In this manner, the internal combustion engine heat pump system is used effectively both for cooling and the accompanying dehumidification of the gaseous medium and for the reheating thereof.

As a technical concept, it is advantageous in this instance for there to be provided a flow circuit in which the cooling operating medium circulates between a cooling heat exchanger system of the cooling device which comprises one or more cooling heat exchangers and the internal combustion engine heat pump system.

With the cooling device, it may be the case that ice forms and has to be removed for correct operation of the conditioning device. Therefore, it is advantageous for the cooling device to comprise a deicing device by means of which one or more cooling heat exchangers of the cooling heat exchanger system can be selectively deiced.

Preferably, the deicing device comprises a circulation line which is connected to the flow circuit for the heating operating medium and which leads to one or more cooling heat exchangers of the cooling heat exchanger system. The heating operating medium is also used in an energy efficient manner for deicing the cooling device.

For the efficient temperature control of the gaseous medium, it is advantageous for there to further be formed in the flow path of the gaseous medium a precooling device which is arranged upstream of the heating device and upstream of the cooling device and/or for there to be formed a preheating device which is arranged upstream of the heating device, and/or for there to be formed another heating device which is arranged downstream of the heating device.

In the installation of the type mentioned in the introduction, the above-mentioned objective may be achieved in that
the conditioning device is a conditioning device having some or all of the above-explained features.

In the method of the type mentioned in the introduction, the above-mentioned objective may be achieved in that
the heating device uses the waste heat of an internal combustion engine of an internal combustion engine heat pump system for heating the gaseous medium.

The advantages of this method feature and the method features which will be explained below correspond to the advantages which have been discussed in relation to the respective features of the conditioning device.

Accordingly, a heating operating medium is advantageously circulated in a flow circuit for the heating operating medium between at least one heating heat exchanger of the heating device and the internal combustion engine heat pump system, wherein the waste heat of the internal combustion engine is transferred by means of a waste heat exchanger to the heating operating medium.

Preferably, the flow circuit comprises a feed line which leads from the waste heat exchanger to the heating heat exchanger of the heating device and a return line between the heating heat exchanger and the waste heat exchanger, wherein the feed line and the return line are connected to each other by means of a circulation line and the heating operating medium from the feed line in the circuit is guided into the return line again.

It is advantageous for the circulation line upstream of the heating heat exchanger to extend away from the feed line.

It is advantageous for the proportion of the heating operating medium which flows from the feed line into the return line to be adjusted by means of a valve.

It is particularly preferable for:
a) there to be formed in the flow path for gaseous medium at least one cooling device by means of which the gaseous medium is cooled and which is arranged in particular upstream of the heating device;
b) the cooling device to be connected to the internal combustion engine heat pump system and a cooling operating medium which is cooled by the internal combustion engine heat pump system to be used to cool the gaseous medium.

It is further advantageous for the cooling operating medium to circulate in a flow circuit between a cooling heat exchanger system of the cooling device, which comprises one or more cooling heat exchangers, and the internal combustion engine heat pump system.

Preferably, one or more cooling heat exchangers of the cooling heat exchanger system are selectively deiced by means of a deicing device.

It is advantageous for the deicing device to comprise a circulation line which is connected to the flow circuit for the heating operating medium and which leads to one or more cooling heat exchangers of the cooling heat exchanger system.

It is further advantageous for the gaseous medium to be further precooled on the flow path thereof by means of a precooling device which is arranged upstream of the heating device and upstream of the cooling device, and/or to be preheated by a preheating device which is arranged upstream of the heating device and/or to be heated by means of an additional heating device which is arranged downstream of the heating device.

Other advantages and aspects of the present invention will become apparent upon reading the following description of the drawings and detailed description of the invention.

### BRIEF DESCRIPTION OF THE DRAWINGS

Embodiments of the invention will be explained in greater detail below with reference to the drawings, in which:

FIG. 1 is a longitudinal section of a processing device for processing vehicle bodyworks with a processing tunnel to which process air which has been conditioned by means of a conditioning device with several conditioning steps according to a first embodiment is supplied;

FIG. 2 shows the first embodiment of the conditioning device according to FIG. 1, wherein a supply circuit of the conditioning steps is schematically illustrated;

FIG. 3 shows the first embodiment of the conditioning device according to FIG. 1, wherein a second supply layout of the conditioning steps is schematically illustrated;

FIG. 4 shows a second embodiment of the conditioning device having a supply layout.

A conditioning device for conditioning a gaseous medium 12 to form a conditioned gaseous process medium 14 is designated 10 in the Figures.

### DETAILED DESCRIPTION OF THE INVENTION

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

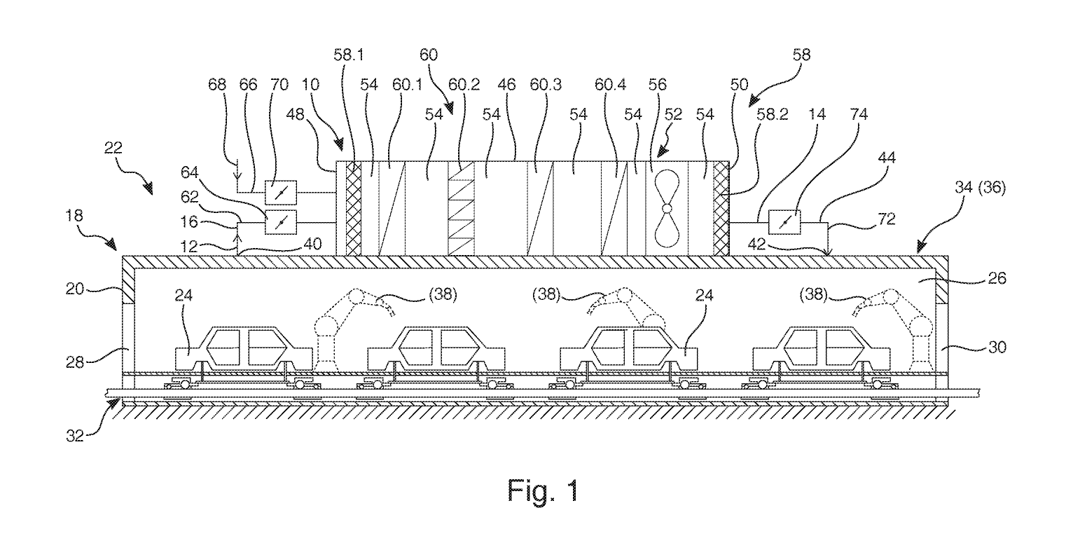

Such a gaseous medium 12 may, for example, contain an exhaust gas which is produced during a work process. In the embodiments described below, the gaseous medium 12 is, for example, at least partially exhaust air 16 which is produced in a processing device 18 shown only in FIG. 1 with a processing booth 20 of an installation which is generally designated 22 for processing workpieces.

Vehicle bodyworks are shown in each case as an example of workpieces 24, which is intended to be understood to be bodyworks of both passenger vehicles and lorries including passenger compartments. The workpieces 24 may, however, also be other workpieces and in particular attachments or surface-mounted parts of vehicle bodyworks, such as bumpers, wing mirrors or the like. Smaller workpieces 24 may where applicable be arranged on a workpiece carrier which is not shown separately.

The processing booth 20 of the processing device 18 delimits an operating space in the form of a processing tunnel 26 with a tunnel inlet 28 and a tunnel outlet 30 which where applicable may be constructed as an input or output airlock, as known per se. The workpieces 24 which are intended to be processed are conveyed by means of a conveyor system 32 through the processing tunnel 26, as is also known per se and which does not have to be discussed in greater detail.

The processing device 18 may, for example, be a dryer 34 in which previously painted workpieces 24 or the paint thereof is dried. The processing device 18 may, however, also be in particular a painting booth 36 which is illustrated in FIG. 1 by means of associated painting robots 38 which are shown with broken lines in order to illustrate the alternative. As mentioned in the introduction, flash-off booths, cooling booths or the like with one processing tunnel in each case are also considered.

The processing tunnel 26 has one or more air outlets 40 and one or more air inlets 42 between which the conditioning device 10 is arranged so that exhaust air 16 is drawn from the processing tunnel 26, conveyed through the conditioning device 10 and after completed conditioning can be supplied to the processing tunnel 26 again as process air 44 in a circuit which in the present embodiment is consequently the conditioned gaseous process medium 14. The returned process air 44 is guided in a dryer 34 in a manner known per se by means of nozzles which are not illustrated separately to the workpieces 24 which are intended to be processed. In a painting booth 36, the conditioned gaseous process medium 14 is generally guided by means of an air plenum on the ceiling of the painting booth 26 into the processing tunnel 26; this is known per se.

In this manner, it is possible in the processing tunnel 26 to maintain the temperature required for effective processing and processing conditions. In a modification which is not shown separately, the processing tunnel 26 can also be subdivided into a plurality of tunnel portions which each have a separate air outlet and air inlet which are connected to the conditioning device 10. Where applicable, a separate conditioning device 20 may also be associated with each tunnel portion present so that in each tunnel portion different temperatures and processing conditions can be adjusted as is most favorable for the processing operation.

As a result of the conditioning device 10, in particular the temperature and the humidity of the process medium 14 are adjusted. In a dryer 34, for example, the process medium 14 at higher temperatures should have only a very low level of humidity.

The conditioning device 10 comprises a housing 46 having an inlet connection device 48 and an outlet connection device 50, between which a flow path for gaseous medium 12 with a plurality of conditioning steps 52 is formed. The flow direction in the conditioning device 10 is consequently defined from the inlet connection device 48 to the outlet connection device 50.

There are arranged between the individual conditioning steps 52 flow regions 54 which are provided with a reference numeral only in FIG. 1. The conditioning steps 52 and the flow regions 54 are generally accommodated in separate chambers which are connected to each other in technical flow terms; however, this is not shown separately here. In a modification, some or all conditioning steps 52 and flow regions 54 without a separate chamber housing can also be accommodated in the housing 46.

The conditioning device 10 further comprises one or more ventilator devices 56 by means of which the medium 12 which is intended to be conditioned is drawn from the processing tunnel 26—and where applicable other media from other sources—and conveyed through the conditioning device 10. In the present embodiment, a single such ventilator device 56 is illustrated.

The inlet connection device 48, the outlet connection device 50 and also the conditioning steps 52, the flow regions 54 and the ventilator device 56 of the conditioning device 10 may be constructed as modules so that the sequence of specific conditioning steps 52 and the arrangement and number of flow regions 54 of the conditioning device 10 can be varied substantially as desired and can be adapted during assembly to the requirements of the processing device 18.

The conditioning device 10 is configured in such a manner that it at least dehumidifies the gaseous medium 12.

In the embodiment of the conditioning device 10 shown in FIGS. 1, 2 and 3, there are by way of example six conditioning steps 52 which comprise two cleaning steps 58 and four temperature control steps 60 which also lead to dehumidification of the gaseous medium 12. In the flow direction, the conditioning steps 52 comprise an inlet filter device 58.1, a precooling device 60.1, a cooling device 60.2, a preheating device 60.3, a heating device 60.4 and an outlet filter device 58.2. The ventilator device 56 is in this embodiment arranged between the heating device 60.4 and the outlet filter device 58.2, but may also be positioned at another location. Additionally or alternatively to the inlet filter device 58.1 or the outlet filter device 58.2, one or more filter devices may also be provided at another location in the flow path between the inlet connection device 48 and the outlet connection device 50.

The air outlet 40 of the processing tunnel 26 which can be seen in FIG. 1 is connected by means of a flow line 62 to the inlet connection device 48 of the conditioning device 10 so that the gaseous medium 12 which is intended to be conditioned can flow into the conditioning device 10. In the flow line 62, a valve 64 is arranged so that the volume flow of the exhaust air 16 to the inlet connection device 48 can be adjusted.

Furthermore, the inlet connection device 48 is connected to a fresh air line 66 via which fresh air 68 can be supplied to the conditioning device 10. In the fresh air line 66, a valve 70 is arranged so that the volume flow of the fresh air 68 can also be adjusted. The conditioning operation for the gaseous medium 12, that is to say, in this instance for the exhaust air 16 from the processing tunnel 26, also includes a proportion of an additive gas, in this instance, therefore, a proportion of fresh air 68, being added to the gaseous medium 12. A mixture of the gaseous medium 12 and fresh air 68 consequently generally always flows through the conditioning device 10 downstream of the ventilator device 56; for the sake of simplicity, only the gaseous medium 12 will nonetheless be mentioned below.

The outlet connection unit 50 of the conditioning device 10 is connected by means of another flow line 72 having a valve 74 to the air inlet(s) 42 of the processing device 18 by means of which the conditioned process medium 14 can flow to the processing tunnel 26. In a modification, a proportion of the conditioned process medium 14 can be branched off from or upstream of the outlet connection device 50 and supplied for another use.

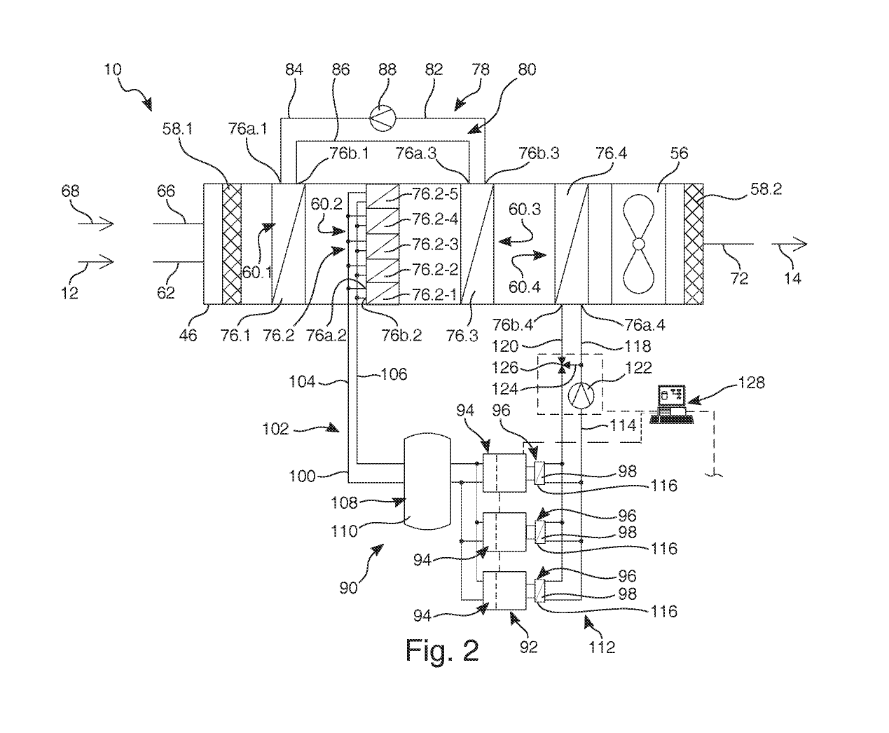

The conditioning device 10 is explained below with reference to FIG. 2.

The temperature stages 60 are designed as heat exchangers 76 each having an inlet and an outlet for an operating medium, as shown in the Figures by way of example. In this instance, a precooling heat exchanger 76.1 in the precooling device 60.1, a cooling heat exchanger system 76.2 in the cooling device 60.2, a preheating heat exchanger 76.3 in the preheating device 60.3 and a heating heat exchanger 76.4 in the heating device 60.4 are illustrated. The respective inlets and outlets of the heat exchangers for the respective operating medium are designated 76a.1, 76b.1, 76a.2, 76b.2, etcetera.

Whilst the precooling device 60.1, the preheating device 60.3 and the heating device 60.4 are each configured with a heat exchanger, the cooling heat exchanger system 76.2 of the cooling device 60.2 comprises a plurality of cooling heat exchangers, wherein, in the present embodiments, five such cooling heat exchangers 76.2-1, 76.2-2, 76.2-3, 76.2-4 and 76.2-5 are shown. The cooling heat exchanger system 76.2 may, however, also comprise fewer or more than five cooling heat exchangers. Each of these cooling heat exchangers 76.2-1, 76.2-2, 76.2-3, 76.2-4 and 76.2-5 has an inlet 76a.2 and an outlet 76b.2, of which only one is indicated for reasons of clarity.

In a modification which is not shown separately, the precooling device 60.1, the preheating device 60.3 and the heating device 60.4 may also be constructed as heat exchanger systems with a plurality of heat exchangers and consequently correspond in terms of their concept to that of the cooling heat exchanger system 76.2.

The precooling heat exchanger 76.1 and the preheating heat exchanger 76.3 are components of a first composite circuit system 78. In this first composite circuit system 78, there is constructed a single flow circuit 80 in which an operating medium 82 circulates between the precooling heat exchanger 76.1 and the preheating heat exchanger 76.3. To this end, the inlet 76a.1 of the precooling heat exchanger 76.1 is connected by means of a fluid line 84 to the outlet 76b.3 of the preheating heat exchanger 76.3 and the outlet 76b.1 of the precooling heat exchanger 76.1 is connected via a fluid line 86 to the inlet 76a.3 of the preheating heat exchanger 76.3. A conveying pump 88 is arranged in the fluid line 84. The operating medium 82 which is preferably a glycol/water admixture with 30% by volume glycol, is in this instance guided in a continuous circuit through the precooling heat exchanger 76.1 and the preheating heat exchanger 76.3.

The cooling heat exchanger system 76.2 and the heating heat exchanger 76.4 are components of a second composite circuit system 90 which comprises an internal combustion engine heat pump system 92 with at least one heat pump 94. In the present embodiment, three heat pumps 94 which are connected in parallel are shown, but alternatively only one or two or also more than three heat pumps 94 may be present. The required number of heat pumps 94 is dependent in particular on the mass flows of the operating media which are intended to be temperature controlled.

Each heat pump 94 has in a manner known per se an evaporator unit, a compressor unit, a condenser unit and a throttle unit which are arranged in an operating circuit through which an operating fluid is guided; these components are not shown separately.

In order to drive the compressor unit of the heat pump 94, it comprises an internal combustion engine 96 which in the present embodiment is a gas motor 98. The heat pump 94 is thus in the present embodiment a gas engine heat pump.

Alternatively, an oil engine can also be used as an internal combustion engine 96. In this instance, the heat pump 94 is an oil engine heat pump.

The heat pump 94 serves to cool a cooling operating medium 100 in the form of a brine which will also be designated 100 below and which circulates in a first flow circuit 102 of the second composite circuit system 90 between the heat pump 94 and the cooling heat exchanger 76.2 of the cooling device 60.2. The brine 100 is preferably a mixture of water and glycols, in particular ethylene glycols or propylene glycols, with additional corrosion inhibitors, as known per se. The first flow circuit 102 comprises a feed line 104 which leads from the evaporator side of the heat pumps 94 to the inlets 76a.2 of the cooling heat exchanger system 76.2, 76.2-3, 76.2-4 and 76.2-5 of the cooling device 60.2 and a return line 106 between the outlets 76b.2 of the cooling heat exchanger 76.2 and the evaporator side of the heat pumps 94. At the inlets 76a.2 a conveyor pump which is not shown separately in each case is present so that the influx of the brine 100 to the individual cooling heat exchangers 76.2-1, 76.2-2, 76.2-3, 76.2-4 and 76.2-5 can be controlled individually in each case.

The feed line 104 and the return line 106 are in a manner known per se decoupled from each other by means of a compensation device 108 in order to compensate for different levels of circulation flows in the feed line 104 and the return line 106. To this end, a hydraulic switch 110 is provided.

Between the compensation device 108 and the heat pumps 94 in each associated feed line a conveying pump which is not shown separately is also arranged so that the influx of the brine 100 from each heat pump 94 into the first flow circuit 102 can be controlled individually in each case.

The second composite circuit system 90 comprises in addition to the first flow circuit 102 a second flow circuit 112 for a heating operating medium 114 in which this heating operating medium 114 circulates between the heating heat exchanger 76.4 and the heat pumps 94 which are provided in each case, wherein the waste heat of the internal combustion engines 96 is transferred to the heating operating medium 114. To this end, each heat pump 94 comprises a waste heat exchanger 116 through which the second flow circuit 112 leads. The heating operating medium 114 of the second flow circuit 102 is preferably again a glycol/water admixture with 30% by vol. glycol.

As a result of the second flow circuit 122, there are generally speaking produced means via which the heating device 60.4 uses the waste heat of the internal combustion engines 96 of the internal combustion engine heat pump system 92 for heating the gaseous medium 12.

The second flow circuit 112 comprises a feed line 118 which leads from the waste heat exchanger 116 to the inlet 76a.4 of the heating heat exchanger 76.4 of the heating device 60.4 and a return line 120 between the outlet 76b.4 of the heating heat exchanger 76.4 and the waste heat exchanger 116. In the feed line 118, a conveying pump 122 for the heating operating medium 114 is arranged.

The feed line 118 and the return line 120 are connected to each other by means of a circulation line 124 in such a manner that heating operating medium 114 from the feed line 118 in the circuit can be guided into the return line 120 again. The circulation line 124 extends upstream of the heating heat exchanger 76.4 away from the feed line 118 so that the circulation return of the heating operating medium 114 is carried out in the return line 120 before the heating operating medium 114 flows into the heating heat exchanger 76.4. The proportion of the heating operating medium 114 which is intended to be returned, that is to say, the proportion of the heating operating medium 114 which flows from the feed line 118 into the return line 120 can be adjusted by means of a valve 126 which in the present embodiment is arranged in the return line 120.

The conveying pump 122 and the valve 126 of the second flow circuit 112 of the second composite circuit system 90 are controlled by means of a control device 128 which is also responsible for the control of the heat pump system 92. The conveying pump 88 of the first composite circuit system 78 and other conveying pumps and valves which are present and which where applicable are not shown separately are also controlled by means of the control device 128. For example, this includes in particular the conveying pumps explained above at the inlets 76a.2 of the cooling heat exchanger system 76.2.

The conditioning device 10 shown in FIGS. 1 and 2 functions as follows, wherein the temperatures set out below serve only for illustration and reflect exemplary values which may occur in practice in a dryer 34 in which painted vehicle bodyworks are dried. The temperatures set out reflect in particular the relationships which the temperatures which occur may have with respect to each other. The temperatures which actually occur with a specific processing device 18 are dependent on the individual operating parameters of the processing device 18 and the associated conditioning device 10.

The exhaust air 16 from the processing tunnel 26 has a temperature T₁=65° C., whereas the fresh air 68 in the fresh air line 66 is guided at a temperature T₂=32° C. The flow relationships of exhaust air 16 and fresh air 68 are adjusted in such a manner that the gaseous medium 12 which is produced as a result of mixing in the region of the inlet filter device 58.1 has a temperature T₃=56° C.

The gaseous medium 12 flows through the precooling heat exchanger 76.1 of the precooling device 60.1 to which the operating medium 82 of the flow circuit 80 of the first composite circuit system 78 is supplied at a temperature T₄=8° C.

After flowing through the precooling device 60.1, the gaseous medium 12 has a temperature of T₅=17° C., wherein the operating medium 82 leaves the precooling heat exchanger 76.1 at a temperature T₆=47° C.

The gaseous medium 12 reaches the cooling device 60.2, wherein the brine 100 of the first flow circuit 102 of the second composite circuit system 90 flows into the cooling heat exchanger system 76.2 thereof at a temperature T₇=−4° C. The gaseous medium 12 is cooled by the cooling device 60.2 to a temperature T₈=−2° C., wherein the brine 100 leaves the cooling heat exchangers 76.2-1, 76.2-2, 76.2-3, 76.2-4 and 76.2-5 at a temperature T₉=+2° C. The brine 100 is cooled by the heat pump system 92 to the temperature T₇=−4° C. again.

After flowing through the cooling device 60.2, the gaseous medium 12 has a temperature T₁₀=−2° C. The cooling leads to a condensation of the humidity carried by the gaseous medium 12. In order to capture the condensed water, corresponding collection devices which are known per se and which are therefore not shown separately are provided.

The gaseous medium 12 now reaches the preheating device 60.3 in the preheating heat exchanger 76.3 of which the operating medium 82 of the first composite circuit system 80 flows at the above-mentioned temperature T₆=47° C. and leaves at the temperature T₄=8° C. and flows to the precooling device 60.1. The gaseous medium 12 leaves the preheating device 60.3 at a temperature T₁₁=37° C. and flows further to the heating device 60.4. The heating operating medium 114 in the second flow circuit 112 of the second composite circuit system 90 is heated by means of the waste heat exchanger 116 in such a manner that it flows into the heating heat exchanger 76.4 at a temperature T₁₂=60° C. The heating operating medium 114 leaves the heating heat exchanger 76.4 at a temperature T₁₃=40° C.

The gaseous medium 12 has after flowing through the heating heat exchanger 76.4 a temperature T₁₄=51° C., flows through the outlet filter device 58.2 and leaves the conditioning device 10 as conditioned process gas 14 which accordingly also has the temperature T₁₄=51° C. and is guided back into the processing tunnel 26.

During operation of the conditioning device 10, it may be the case that the cooling heat exchangers 76.2-1, 76.2-2, 76.2-3, 76.2-4 and 76.2-5 of the cooling heat exchanger system 76.2 become iced since the brine 100 is supplied to them at a temperature below 0° C.

Therefore, measures may be applied in order to be able to selectively device the cooling heat exchangers 76.2-1, 76.2-2, 76.2-3, 76.2-4 and 76.2-5.

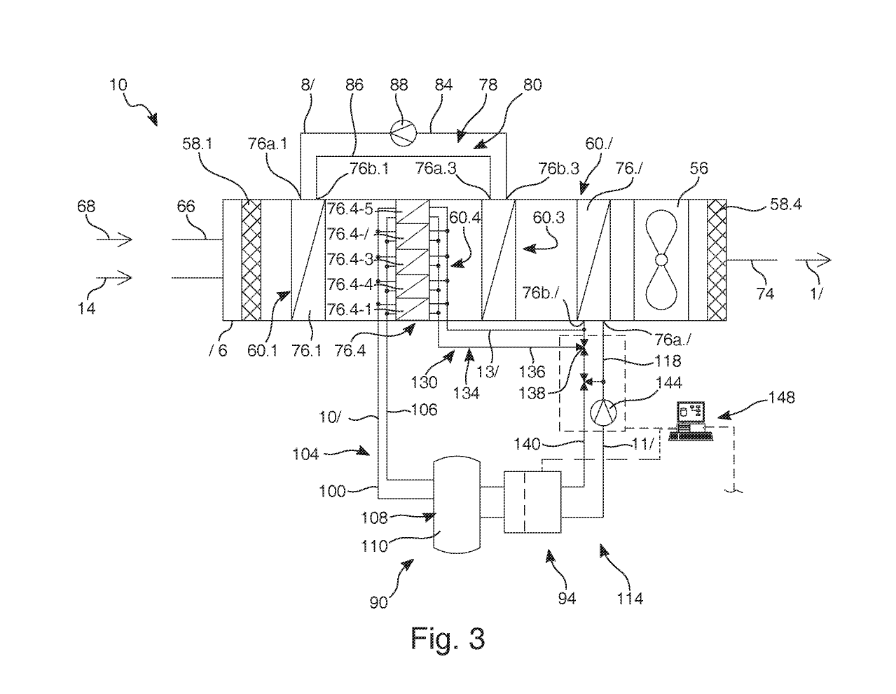

FIG. 3 shows a corresponding modification in which the cooling device 60.2 comprises a deicing device 130 by means of which one or more cooling heat exchangers 76.2-1, 76.2-2, 76.2-3, 76.2-4 and 76.2-5 of the cooling heat exchanger system 76.2 can be selectively deiced. In FIG. 3, the heat pump system 92 is illustrated for clarity only schematically without the components shown in FIG. 2.

The deicing device 130 comprises a circulation line 132 having a feed line 134 and a return line 136, whose inlet and outlet are connected to the second flow circuit 112 of the second composite circuit system 90, in the present example, to the return line 120 thereof, and which leads to the individual cooling heat exchangers 76.2-1, 76.2-2, 76.2-3, 76.2-4 and 76.2-5 of the cooling heat exchanger system 76.2, so that heating operating medium 114 which flows out of the heating heat exchanger 76.4 can be guided through the cooling heat exchangers 76.2-1, 76.2-2, 76.2-3, 76.2-4 and 76.2-5. The influx of heating operating medium 114 via the circulation line 132 through the cooling heat exchangers 76.2-1, 76.2-2, 76.2-3, 76.2-4 and 76.2-5 is controlled by means of valves which are not shown separately and which are controlled by means of the control device 128. The return line 136 of the circulation line 132 opens via a valve 138 in the return line 120 of the second flow circuit 112 of the second composite circuit system 90.

The heating operating medium 114 has in the return line 120 the above-explained temperature T₁₃=40° C. and also reaches the cooling heat exchanger system 76.2 at approximately this temperature. If the access to one of the cooling heat exchangers 76.2-1, 76.2-2, 76.2-3, 76.2-4 or 76.2-5 is released, the respective cooling heat exchanger 76.2-1, 76.2-2, 76.2-3, 76.2-4 and 76.2-5 becomes heated and is deiced in this manner.

In the embodiment according to FIG. 3, the temperature at which the brine 100 enters the cooling heat exchanger system 76.2 is T₇=−2° C. The discharge temperature at which the brine 100 leaves the cooling heat exchanger system 76.2 is in this instance T₉=+3° C.

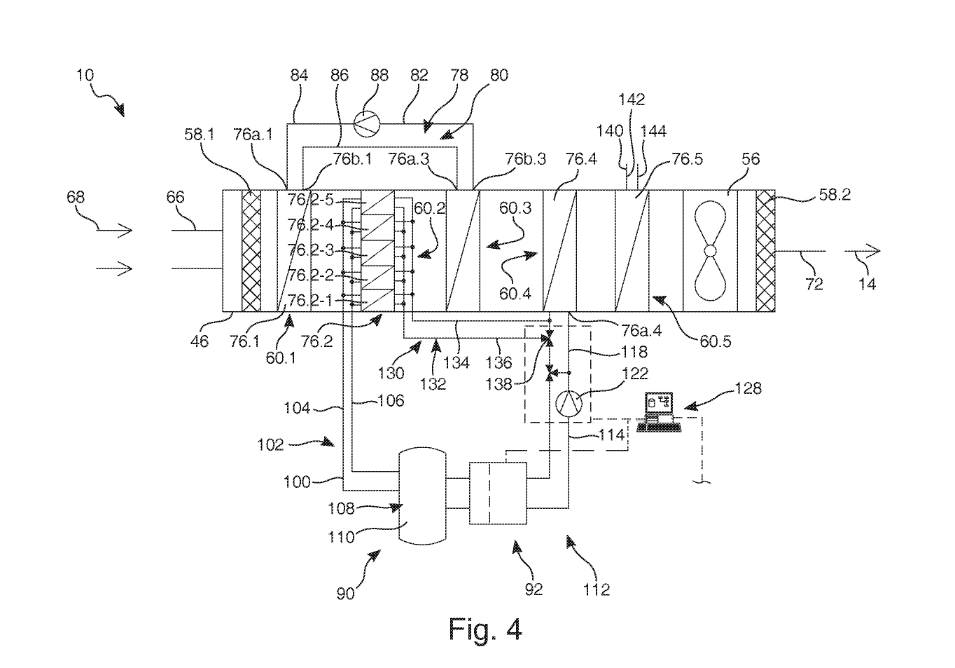

FIG. 4 shows another embodiment of the conditioning device 10, in which it comprises in the flow direction downstream of the heating device 60.4 another temperature control stage 60 in the form of another heating device 60.5 with another heating heat exchanger 76.5. This heat exchanger is supplied via a supply line 140 with an operating medium 142 which flows into the additional heating heat exchanger 76.5 at a temperature T₁₅=90° C. The operating medium 142 leaves the additional heating heat exchanger 76.5 via a discharge line 144 at a temperature T₁₆=70° C.

The gaseous medium 12 reaches the additional heating device 60.5 at the temperature T₁₄=51° C. and afterward has a temperature T₁₇=65° C. Consequently, conditioned process gas 14 which leaves the conditioning device 10 also has this temperature T₁₇=65° C. In this instance, the returned conditioned process gas 14 consequently has the same temperature as the gaseous medium 12 which is discharged from the processing tunnel 26 at a temperature T₁=65° C.

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

What is claimed is:

1. A conditioning device for conditioning a gaseous medium to form a conditioned gaseous process medium, comprising:
an inlet connection device and an outlet connection device between which a flow path for gaseous medium having at least one heating device, by means of which the gaseous medium can be heated, is formed,
wherein
the at least one heating device is connected to an internal combustion engine heat pump system having at least one internal combustion engine in such a manner that the waste heat of the at least one internal combustion engine can be used to heat the gaseous medium.

2. The conditioning device according to claim 1, wherein there is provided a flow circuit for a heating operating medium in which the heating operating medium circulates between at least one heating heat exchanger of the at least one heating device and the at least one internal combustion engine heat pump system, wherein the waste heat of the at least one internal combustion engine is transferred by means of a waste heat exchanger to the heating operating medium.

3. The conditioning device according to claim 2, wherein the flow circuit comprises a feed line which leads from the waste heat exchanger to the at least one heating heat exchanger of the at least one heating device and a return line between the at least one heating heat exchanger and the waste heat exchanger, wherein the feed line and the return line are connected to each other by means of a circulation line in such a manner that heating operating medium from the feed line in the circuit can be guided into the return line again.

4. The conditioning device according to claim 3, wherein the circulation line extends upstream of the at least one heating heat exchanger away from the feed line.

5. The conditioning device according to claim 3, wherein there is provided a valve by means of which it is possible to adjust the proportion of the heating operating medium which flows from the feed line into the return line.

6. The conditioning device according to claim 1, wherein
a) there is formed in the flow path for gaseous medium at least one cooling device by means of which the gaseous medium can be cooled and which is arranged in particular upstream of the at least one heating device;
b) the at least one cooling device is connected to the internal combustion engine heat pump system in such a manner that a cooling operating medium which is cooled by the internal combustion engine heat pump system can be used to cool the gaseous medium.

7. The conditioning device according to claim 6, wherein there is provided a flow circuit in which the cooling operating medium circulates between a cooling heat exchanger system of the at least one cooling device which comprises one or more cooling heat exchangers and the internal combustion engine heat pump system.

8. The conditioning device according to claim 7, wherein the at least one cooling device comprises a deicing device by means of which one or more cooling heat exchangers of the cooling heat exchanger system can be selectively deiced.

9. The conditioning device according to claim 2, wherein
a) there is formed in the flow path for gaseous medium at least one cooling device by means of which the gaseous medium can be cooled and which is arranged in particular upstream of the at least one heating device;
b) the at least one cooling device is connected to the internal combustion engine heat pump system in such a manner that a cooling operating medium which is cooled by the internal combustion engine heat pump system can be used to cool the gaseous medium, and
there is provided a flow circuit in which the cooling operating medium circulates between a cooling heat exchanger system of the at least one cooling device which comprises one or more cooling heat exchangers and the internal combustion engine heat pump system, and
the at least one cooling device comprises a deicing device by means of which one or more cooling heat exchangers of the cooling heat exchanger system can be selectively deiced, the deicing device comprising a circulation line which is connected to the flow circuit for the heating operating medium and which leads to one or more cooling heat exchangers of the cooling heat exchanger system.

10. The conditioning device according to claim 1, wherein there is further formed in the flow path of the gaseous medium a precooling device which is arranged upstream of the at least one heating device and/or there is formed a preheating device which is arranged upstream of the at least one heating device and/or there is formed another heating device which is arranged downstream of the at least one heating device.

11. An installation for processing workpieces, comprising:
a conditioning device for conditioning a gaseous medium to form a conditioned gaseous process medium, wherein the conditioning device is a conditioning device according to claim 1.

12. A method for operating a conditioning device for conditioning a gaseous medium to form a conditioned gaseous process medium, comprising:
forming a flow path for gaseous medium between an inlet connection device and an outlet connection device, the flow path for the gaseous medium having at least one heating device by means of which the gaseous medium can be heated
wherein
the at least one heating device uses the waste heat of an internal combustion engine of an internal combustion engine heat pump system for heating the gaseous medium.

13. The method according to claim 12, wherein a heating operating medium is circulated in a flow circuit for the heating operating medium between at least one heating heat exchanger of the at least one heating device and the internal combustion engine heat pump system, wherein the waste heat of the internal combustion engine is transferred by means of a waste heat exchanger to the heating operating medium.

14. The method according to claim 13, wherein the flow circuit comprises a feed line which leads from the waste heat exchanger to the at least one heating heat exchanger of the at least one heating device and a return line between the at least one heating heat exchanger and the waste heat exchanger, wherein the feed line and the return line are connected to each other by means of a circulation line and the heating operating medium from the feed line in the circuit is guided into the return line again.

15. The method according to claim 14, characterized in that the circulation line upstream of the at least one heating heat exchanger extends away from the feed line.

16. The method according to claim 14, wherein the proportion of the heating operating medium which flows from the feed line into the return line is adjusted by means of a valve.

17. The method according to claim 12, wherein
a) there is formed in the flow path for gaseous medium at least one cooling device by means of which the gaseous medium is cooled and which is arranged in particular upstream of the at least one heating device;
b) the at least one cooling device is connected to the internal combustion engine heat pump system and a cooling operating medium which is cooled by the internal combustion engine heat pump system is used to cool the gaseous medium.

18. The method according to claim 17, wherein the cooling operating medium circulates in a flow circuit between a cooling heat exchanger system of the at least one cooling device, which comprises one or more cooling heat exchangers, and the internal combustion engine heat pump system.

19. The method according to claim 18, wherein one or more cooling heat exchangers of the cooling heat exchanger system are selectively deiced by means of a deicing device.

20. The method according to claim 13, wherein
a) there is formed in the flow path for gaseous medium at least one cooling device by means of which the gaseous medium is cooled and which is arranged in particular upstream of the at least one heating device;
b) the at least one cooling device is connected to the internal combustion engine heat pump system and a cooling operating medium which is cooled by the internal combustion engine heat pump system is used to cool the gaseous medium, and
the cooling operating medium circulates in a flow circuit between a cooling heat exchanger system of the at least one cooling device, which comprises one or more cooling heat exchangers, and the internal combustion engine heat pump system, and further wherein
one or more cooling heat exchangers of the cooling heat exchanger system are selectively deiced by means of a deicing device, the deicing device comprising a circulation line which is connected to the flow circuit for the heating operating medium and which leads to one or more cooling heat exchangers of the cooling heat exchanger system.

21. The method according to claim 12, wherein the gaseous medium is further precooled on the flow path thereof by means of a precooling device which is arranged upstream of the at least one heating device and/or is preheated by means of a preheating device which is arranged upstream of the at least one heating device and/or is heated by means of an additional heating device which is arranged downstream of the at least one heating device.
